(19) United States
(12) Patent Application Publication
(10) Pub. No.: US 2025/0075110 A1
(43) Pub. Date: Mar. 6, 2025

(54) Industrial Applications for Specialty Pea Flour

(71) Applicant: Louis Dreyfus Company Plant Proteins LLC, Livermore, CA (US)

(72) Inventors: Prasanth Kumar Sasidharan Pillai, Livermore, CA (US); Manoj Kumar, Livermore, CA (US)

(21) Appl. No.: 18/792,403

(22) Filed: Aug. 1, 2024

Related U.S. Application Data
(60) Provisional application No. 63/536,024, filed on Aug. 31, 2023.

(51) Int. Cl. C09J 103/02; B27D 1/06; B28B 19/00; C04B 28/14; C04B 111/00; C09J 5/00; D21H 27/32; D21J 3/00; E04C 2/04; E04C 2/12; E04C 2/16

(52) U.S. Cl. CPC C09J 103/02; B27D 1/06; C04B 28/14; C09J 5/00; D21H 27/32; D21J 3/00; E04C 2/043; E04C 2/12; E04C 2/16; B28B 19/0092; C04B 2111/0062

(57) ABSTRACT

Methods of producing specialty pea flour (SPF) are provided, as well as the SPF produced by such methods, compositions comprising the SPF and uses for the SPF. In addition, enzyme modified SPF, including amylase treated specialty pea flour (ASPF) and composition comprising ASPF and uses for the ASPF are provided.

### CROSS-REFERENCE

This application claims benefit of U.S. Provisional Patent Application No. 63/536,024 filed Aug. 31, 2023, which application is incorporated herein by reference in its entirety.

### BACKGROUND OF THE INVENTION

Plant derivatives such as starch have been widely used in the textile industry, in the production of adhesives and the modification of paper products. The predominant source of starch in both the food industry and the others mentioned above is corn starch (Maize starch). Another less-often used starch is derived from potatoes. With the push for green products that are plant based and have lower toxicities, the production of new plant-based products that may have applications in various industries is in great demand.

Products from legumes, such as peas, have found a wide variety of applications in the food and beverage industry, but have not seen abundant applications otherwise. U.S. Pat. No. 4,942,191 (expired) claimed an adhesive composition comprising a curable aldehyde condensation resin and an extender comprising leguminous flour. U.S. Patent Application Publication No. US 2022-0363866 A1 describes a composition comprising ground plant seeds, protein isolate, starch or a mixture of these, a metal oxide, and a plasticizer to use for adhesion or extrusion. European patent application publication No. EP4183815A1 describes an adhesive comprising ground pea seeds and an amine-based aziridinium-functional cross-linker and water. Development of plant-based industrial compositions to expand the possibilities of green building materials and products are in great demand.

### SUMMARY OF THE INVENTION

The present invention provides specialty pea flour (SPF) that finds applications in paper and cardboard manufacturing, use as an adhesive, and applications in the production of fiber board, printing and writing papers, paper boards. These applications include corrugating adhesive, laminating adhesive, wet end starching, surface sizing of printing and writing papers and paperboard, surface sizing of recycled linerboard.

Additional applications include dry wall, fiberglass insulation, wood charcoal briquettes pelleting, hydroseeding and hydromulching, and plywood, among others. The specialty pea flour is high in starch and some fiber and relatively low in protein, oil, and other components.

In one aspect of the invention is provided a method of producing a specialty pea flour comprising hydrating pea flour from crushed or milled pea pulses in a water slurry at a flour to water ratio of 1:2 to 1:6 (weight to weight), a pH of 7.5-10 and a temperature of 45-60° C., separating the SPF from the supernatant, washing the separate SPF and drying the separated SPF. In certain embodiments the hydrating is performed at a flour to water ratio of 1:4 (w:w). In some embodiments the hydrating is performed at pH 9.5. In some embodiments, the hydrating is performed at 55° C. In certain embodiments the hydrating is performed for 20-60 minutes. In some embodiments the hydrating is performed for 30 minutes. In certain embodiments the separating is performed by centrifugation and/or decanting. In some embodiments the separating involves centrifuging at 5000 g for 10 minutes. In certain embodiments the washing is performed with water. In some embodiments the washing is at a flour to water ratio of 1:3 (w:w). In certain embodiments the washing is performed at pH 7.5-10. In certain embodiments the washing is performed at a temperature of 45-60° C. In some embodiments the washing is performed at 55° C. In certain embodiments the washing is performed for 10-60 minutes. In other embodiments, the washing is performed for 15-20 minutes. In some embodiments, the drying is to a moisture content of 7-10%. In certain embodiments, the ring dryer drying is performed at 140° C. inlet and 65° C. outlet. In certain embodiments the drying can also be done using other drying equipment such as peeler centrifuge, rotatory vacuum drum-filter (RVDF), drum dryer and other such commercial drying equipment.

In another aspect of the invention, a specialty pea flour produced by the preceding methods is provided. In yet another aspect of the invention, an SPF is provided comprising, on a dry basis, 60-85% starch, 5-20% fiber and 0.5-3% protein and is derived from peas. In some embodiments the starch of the SPF is 30-35% amylose. In some embodiments the SPF further comprises 0.3-0.5% oil, 0.1-0.7% ash, ≤2% sugar and 2-3% resistant starch.

In a different aspect of the invention, a method of making a specialty pea flour composition is provided by combining the specialty pea flour described above and water to form a slurry. In certain embodiments the concentration of SPF in such method is 1-15% solids. In some embodiments the concentration of SPF in such method is 2-10% solids. In some embodiments the concentration is greater than 15%. In certain embodiments the slurry is heated. In some embodiments the method further comprises heating the slurry to 90-120° C. for 10-25 minutes. In some embodiments, the heating is for 20 minutes. In certain embodiments the composition is brought to a viscosity of about 500-2000 centipoise (cP). In some embodiments the composition is brought to a viscosity of about 18700-1900 cP.

In another aspect of the invention, a specialty pea flour composition or a specialty pea flour composition produced by the above method is provided. In a different aspect of the invention, a composition is provided comprising a specialty pea flour, as described above, at a concentration of 2-10% solids, and water. In certain embodiments, the concentration of the composition is about 7% solids. In certain embodiments the composition is at a viscosity of about 500-2000 cP at 60° C. In some embodiments the composition is at a viscosity of about 1870-1900 cP.

In an additional embodiment of the invention, the SPF is enzyme treated. In one embodiment the SPF is treated with an amylase (ASPF). In certain embodiments the SPF or SPF composition is treated with amylase to reduce viscosity. In embodiments of the invention described bellow, ASPF is interchangeable with SPF. The ASPF may be preferred in certain uses where reduced viscosity is preferred. In particular, uses in paper sizing, as described below, are performed with ASPF or SPF, and all references to uses of SPF shall be understood also be uses for ASPF.

In yet another aspect of the invention, a paper composition comprising the SPF described above is provided. In another aspect of the invention, a method of increasing the strength of a paper product comprising applying the SPF composition described above to the paper product is provided. In certain embodiments the strength of the paper product is determined by measuring stiffness using the Technical Association of Pulp and Paper Industry (TAPPI) T 566 standard test.

In another aspect of the invention, a method of adhering or laminating 2 or more paper products to each other is provided, comprising applying to one or more of said paper products the specialty pea flour composition described above and bringing the paper products in contact with each other where the SPF composition has been applied. In certain embodiments one or more of the paper products is corrugated.

In yet another aspect of the invention, a method of improving water resistance of a paper product is provided comprising apply the SPF composition described above to the paper product.

In a different aspect of the invention, a drywall product is provided comprising a panel of gypsum plaster covered by paper and the SPF and/or the SPF composition described above, wherein the paper is adhered to the gypsum panel by the SPF and/or the SPF composition.

In another aspect of the invention, a method of producing a fiber board is provided comprising mixing the SPF described above with water to form a homogeneous adhesive, optionally modifying the SPF, combining a fibrous plant-based material and the SPF or modified SPF and mixing to relative homogeneity and manufacturing a panel from the combined materials using standard molding and compressing techniques. Also provided is a fiber board produced by the preceding method. In addition, a fiber board comprising the SPF described above and/or a modified form of such SPF and a fibrous plant-based material.

In a different aspect of the invention, use of an SPF in the production of a charcoal briquette is provided. In another related aspect, a charcoal briquette comprising SPF is provided.

In a further aspect of the invention, use of SPF in the process of hydroseeding or hydromulching is provided. In a related aspect, a composition for hydroseeding or hydromulching comprising SPF is provided.

In a different aspect of the invention, use of an SPF in the production of a fiberglass insulation product is provided. In another related aspect, a fiberglass insulation product comprising SPF is provided.

In another aspect of the invention, a method of producing plywood is provided comprising mixing SPF as described above with water to form a homogeneous adhesive, optionally modifying such SPF and/or adding an additional component selected from isocyanate, polyvinyl alcohol, citric acid, and/or similar, applying the adhesive to a first veneer, adhering another veneer to said first veneer where the adhesive has been applied and optionally repeating the procedure to add more veneers so as to produce plywood. A plywood produced by such method is also provided. In addition, a plywood comprising the SPF described above as a component of the adhesive adhering the veneers of the plywood is provided.

### BRIEF DESCRIPTION OF THE DRAWINGS

FIGS. 1A-1B show examples of specialty pea flour and commercial corn starch, respectively.

FIG. 2A shows relative particle sizes of specialty pea flour, commercial pea flour and commercial corn starch.

FIG. 2B shows differential scanning calorimetry of specialty pea flour and commercial corn starch.

FIGS. 3A-3B show examples of 7% specialty pea flour composition and 7% commercial corn starch composition, respectively.

FIGS. 4A-4B show Sheffield smoothness analysis of the top side and bottom side, respectively, for base paper coated with specialty pea flour and commercial corn starch compositions.

FIGS. 5A-5B show water resistance analysis of the top side and bottom side, respectively, for base paper coated with specialty pea flour and commercial corn starch compositions.

FIGS. 6A-6B show Taber stiffness analysis in the machine (longitudinal) and cross (transverse) directions, respectively, of base paper coated with specialty pea flour and commercial corn starch compositions.

FIG. 7 shows a plot of the Scott Bond strength vs. composition coat weight for commercial corn starch composition and two different batches of specialty pea flour composition (referred to in the plot legend as okara).

FIGS. 8A-8B show tensile index for different starches tested.

FIGS. 9A-9B show burst index for different starches tested.

FIGS. 10A-10B show tear index for different starches tested.

FIGS. 11A-11B show stretch after sizing of paper for different starches tested.

FIGS. 12A-12B show Cobb size test results for different starches tested.

FIGS. 13A-13B show Taber Stiffness for different starches tested.

FIG. 14 shows several test results for modified CS and ASPF at different coat weights.

FIG. 15 shows several test results for various starches at different coat weights determined in tests independent from those shown in FIG. 14.

### DETAILED DESCRIPTION OF THE INVENTION

The present invention provides novel uses of flour derived from pea pulses, referred to herein as specialty pea flour (SPF), as well as novel products using such SPF and methods to produce such products, including the SPF itself. The invention applies broadly to the production and modification of paper and wood products. The SPF is obtained as a second useful product from a pea protein isolate process.

Before the present processes, compositions and uses are described, it is to be understood that this invention is not limited to the particular methods or compositions described, which may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

“Surface sizing” means the process of applying a substance to the surface of a paper product to impart increased strength or stiffness and/or decrease water absorbance.

“Corrugated” means folded so as to form grooves and ridges.

“Laminating” means the process of bonding layers of material together, such as sheets of paper.

“Base paper” means raw paper stock for coated paper including industrial paper before it is treated.

“Paperboard” means paper sheets 12 points (0.012 inch) or more in thickness.

“Sheet to sheet lamination” means thin sheets of material are bonded in layer-by-layer fashion.

“Paper core” thick-walled cardboard or paper tubes having high strength and resistance to damage.

“Paper tube” cylindrical cardboard tubes made of multiple layers of paper or paperboards.

“Wet end starching” is a process of apply a starch-based additive in paper manufacturing to improve formation, dry strength, and size retention of the paper.

### Specialty Pea Flour (SPF)

SPF, as mentioned above, is a secondary product of a pea protein isolate process. Pea pulses are ground/milled to produce a pea flour. The pea flour is hydrated in water to form a slurry. A homogenizer may be used to make the slurry relatively homogeneous. The flour is mixed in the water at a flour to water ratio of about 1:2 to 1:6 (w:w), frequently in a ration of 1:4 (w:w) at a pH of 7.5-10 and a temperature of 45-60° C. Typically the pH is about 9.5 and the temperature is about 55° C. The hydrating step may last 20-60 minutes, typically about 30 minutes. The flour is then separated from the protein-rich supernatant. The separation of the solids from the supernatant may involve centrifugation, typically at about 5000 g for about 10 minutes, and the supernatant may be decanted off from the solids. The separated pea flour is then washed, typically with water at a flour to water ratio of about 1:3, typically at a pH of 7.5-10, more typically ay a pH of 9.5, and at a temperature of 45-60° C., typically about 55° C. The washing may be done for 20-60 minutes, typically about 30 minutes. The separated, washed pea flour is then dried by standard means generally known to the skilled artisan. Many drying apparatuses are commercially available and the skilled artisan is fully capable of selecting a proper dryer for the present pea flour production.

The production method described above produces a specialty pea flour. The invention provides an SPF that is 60-85% starch, 5-20% fiber and 0.5-3% protein. Typically, the SPF is 70-78% starch, 8-15% fiber and 1-2% protein. The starch component of the SPF is typically about 30-35% amylose. The SPF may also contain 0.3-0.5% oil, 0.1-0.7% ash, ≤2% sugar and 2-3% resistant starch. Additionally, the SPF of the present invention has a mean particle size much larger than either commercial corn starch or commercially available pea flour. The SPF of the invention may have a mean particle size >50 μm. In certain aspects, the mean particle size of the SFP is 70-80 μm. The SPF of the present invention is useful for making various compositions and products, as are more specifically described below.

### Amylase-Treated Specialty Pea Flour

In certain embodiments of the invention, SPF is treated with an enzyme to modify its physical characteristics. In some embodiments, the SPF is treated with amylase to produce amylase treated specialty pea flour (ASPF). ASPF is useful in the same applications as SPF described in this disclosure. ASPF of the invention has the distinction from SPF of the invention of having reduced viscosity in solution. As such, applications that require a less viscous composition or for which lowered viscosity facilitates applying the SPF or is more amenable to a given system may find the ASPF preferable. ASPF has advantages in paper sizing applications, as described below. A person of skill in the art, along with the present disclosure, will be able to determine what form of SPF would work best in a given application of the invention.

### Specialty Pea Flour Compositions

As one possible step in the exploitation of the SPF of this invention, a specialty pea flour composition may be made for use in the surface sizing and adhesion of paper products. In one aspect, an SPF composition is made by a method wherein SPF is combined with water to form a slurry. The concentration of SPF in the water may be 1-15% solids (w:w), or even 2-10% solids (w:w). The skilled artisan will recognize that much higher concentrations of SPF in water are easily obtained and may be desirable for certain applications. The slurry is typically heated, often to a temperature of 90-100° C. The heating may last about 10-20 minutes, although the skilled artisan will know to increase or decreased the temperature and heating time to achieve a desired composition. For certain uses, the method involves bringing the viscosity of the composition to 500-2000 cP at 60° C. For some uses, the method involves bringing the composition to a viscosity of about 1800-1900 cP at 60° C. Several devices are commercially available to determine viscosity, such as the Brookfield viscometer. The skilled artisan will recognize that the viscosity of the composition may be adjusted by varying the temperature and time of the heating step.

### Use of Specialty Pea Flour and Compositions in the Paper and Cardboard Industry

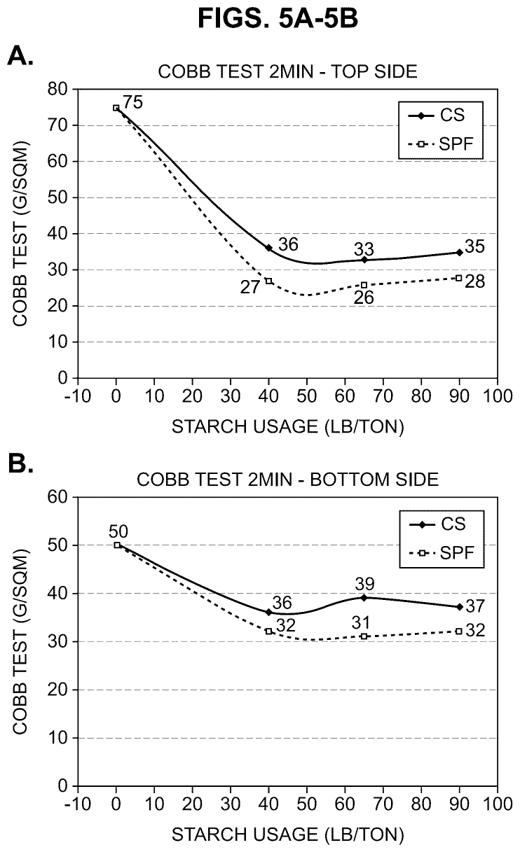

The SPF and SPFD compositions described above have several applications in the paper and cardboard industry. As a first description of this aspect of the invention, a paper composition comprising the SPF or SPF compositions of the invention is provided. The SPF compositions find application in wet-end starching during the paper manufacturing process. The SPF compositions find use in surface sizing of paper products such as printing and writing paper, paperboard and recycled liner board. Example 2, and FIGS. 5A and 5B show the relative smoothness of the surfaces of a base paper product having SPF applied to it as an SPF composition. Smoothness of a surface may be measured using the Sheffield Test, Technical Association of the Pulp and Paper Industry (TAPPI) standard T 538, which measures the smoothness of a surface. This TAPPI standard test, as well as several others, are well know to the skilled artisan and have been used to show the utility and superiority of the present invention over the state of the art, specifically corn starch.

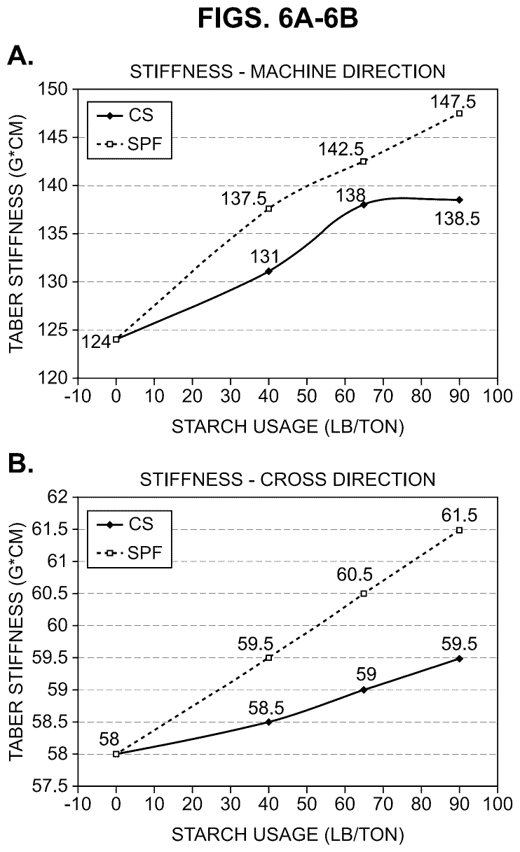

Further to the application of the present invention to the paper products industry, a method of increasing the strength of a paper product is provided by applying to the paper product the SPF compositions of the invention. The strength of a paper product is frequently measured using the Taber Test, TAPPI standard T 566, which measures the stiffness of a paper product by measuring the force necessary to bend a 38.1 mm wide piece of the paper product 15 degrees. The increase stiffness imparted by the SPF of the invention to base paper is shown in FIGS. 6A and 6B, in comparison to corn starch.

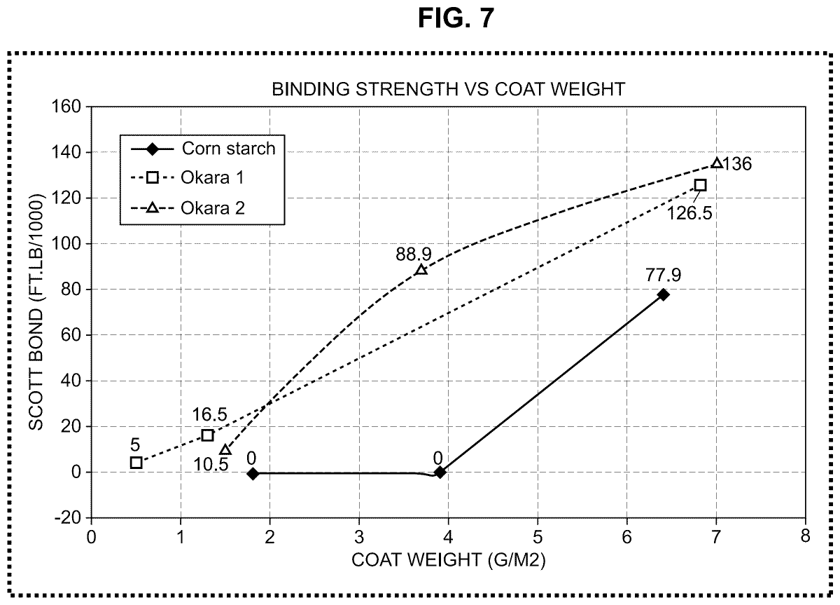

As the skilled artisan will recognize, the SPF compositions of the invention have utility as an adhesive. As such, a method of adhering and/or laminating two or more paper products to each other is provided. The method involves applying an SPF composition of the invention to one or more paper products and bringing the paper products in contact where the SPF composition has been applied. The paper products will adhere to each other by the adhesive properties of the SPF compositions of the invention. The paper products may be pressed or rolled to provide more uniform distribution of the SPF composition and maximize adhesion between the two or more products, as may be customary in the industry. As a point of specific application, one or more of the paper products is corrugated. The skilled artisan will immediately recognize the utility of the SPF compositions in the production of corrugated products such as cardboard. Example 3 shows the binding strength of one exemplary SPF composition using the Scott Bond Test (TAPPI T 569), shown in FIG. 7.

In addition to the adhesive capabilities of the present invention, the SPF, applied as an SPF composition, to a paper product increases the water resistance of the paper product. Water resistance of paper products may be measured using the Cobb Test (TAPPI T 441), which measures the amount of water absorbed by a paper sample over a specified period of time. As such, a method of increasing the water resistance of a paper product by applying a SPF compositions of the invention to the paper product is provided. Specific examples of the measure of water resistance achieved by application of the SPF compositions of the invention to base paper are described in Example 2, and plots of such tests are provided in FIGS. 5A and 5B.

### Other Industrial Applications of Specialty Pea Flour

The present SPF and SPF compositions find utility in several other industrial applications. One example using the adhesive properties of the SPF compositions of the invention is a method of producing a drywall product by providing a gypsum plaster panel and paper to cover the panel, applying an SPF composition of the invention to the panel and/or the paper and contacting the panel with the paper where the composition has been applied such that the paper covers the panel and is adhered to the panel by the SPF composition. Also provided is a drywall product comprising a gypsum plaster panel, paper covering the panel and the SPF of the invention.

Another application of the SPF of the invention is in the manufacture of fiber board. The invention provides a method of producing fiber board by mixing SPF of the invention and water to form a homogeneous adhesive, optionally modifying the SPF, combining a fibrous plant-based material with the PSF or modified PSF adhesive and mixing to relative homogeneity and manufacturing a panel from the combined materials using standard molding and compressing techniques to produce a fiber board. The fibrous plant-based material may be lignocellulose fibers such as wood chips, wood pulp, and other wood products, coconut husks, sugar cane bagasse, straw, hemp, jute, etc. In addition, fiber boards produced by the preceding method and a fiber board comprising the SPF of the invention and a fibrous plant-based material are provided.

Still another application of the invention is in the production of charcoal briquettes. Carbonized wood is crushed and dried and mixed with an accelerant such as sawdust, a non-combustible component such as white ash or limestone and SPF as the binder. Large industrial machine for producing briquettes are available. The mixed components are pressed and dried.

Another application of the SPF is use as a tackifier in hydroseeding and hydromulching. Hydroseeding is a process of applying seeds, stabilizers and soil amendments for revegetation. Seeds, mulch, fertilizer soil amendment (organic material) and tackifier are mixed into a slurry in water and pumped through a hose to cover large areas of land to be planted. The intent is to create an environment where the seeds will germinate and grow. The SPF would be mixed in as a tackifier, acting to cross-link fibers of the components of the mixture to help hold them in place, providing a stable environment for the seeds to grow. SPF is organic and will decompose like the other organic materials in the mixture. Similar mixtures but lacking seeds may be used to help stabilize open ground areas and reduce soil erosion or as dust abatement.

Another application of the SPF of the invention is in the production of fiberglass insulation. The SPF is used as a binder for the glass fibers, replacing the formaldehyde typically used in fiberglass batt production.

Yet another application of the SPF and SPF compositions of the invention is in the manufacture of plywood. A method of producing plywood is provided involving mixing SPF of the invention and water to form an adhesive, optionally modifying the SPF and/or adding an additional component to the homogeneous adhesive, applying the adhesive to a first veneer, and optionally to a second veneer and adhering at least one veneer to the first veneer where the adhesive had been applied, optionally repeating these steps last two steps to add additional veneers, to produce plywood. Optional additional ingredients added to the homogeneous adhesive include isocyanate and/or polyvinyl alcohol citric acid. Also provided are a plywood produced by the preceding method and a plywood having SPF of the invention as a component of the adhesive adhering the veneers of the plywood.

### Exemplary Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-54 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:

1. A method of producing a Specialty pea flour comprising:
a. Hydrating pea flour from ground (milled) pea pulses in a water slurry:
   i) at a flour to water ration of 1:2 to 1:6 (w/v),
   ii) at a pH of 7.5-10,
   iii) at a temperature of 45-60° C.,
b. separating pea flour from protein-rich supernatant,
C. washing the separated pea flour, and
d. drying the separated pea flour,

thereby producing a specialty pea flour.

2. The method of Aspect 1, wherein the hydration is performed at a flour to water ratio of 1:4 (w:w).

3. The method of any of Aspects 1-2, wherein the hydrating is performed at pH 9.5.

4. The method of any of Aspects 1-3, wherein the hydrating is performed at 55° C.

5. The method of any of Aspects 1-4, wherein the hydrating is performed for 20-60 minutes.

6. The method of any of Aspects 1-5, wherein the hydrating is performed for 30 minutes.

7. The method of any of Aspects 1-6, wherein the separating is by centrifugation and/or decanting.

8. The method of any of Aspects 1-7, wherein the separating involves centrifugation at 5000 g for 10 minutes.

9. The method of any of Aspects 1-8, wherein the washing is with water.

10. The method of any of Aspects 1-9, wherein the washing is at a flour to water ratio of 1:3 (w:w).

11. The method of any of Aspects 1-10, wherein the washing is performed at a pH of 7.5-10.

12. The method of any of Aspects 1-11, wherein the washing is performed at a temperature of 45-60° C.

13. The method of any of Aspects 1-12, wherein the washing is performed at a temperature of 55° C.

14. The method of any of Aspects 1-13, wherein the washing is performed for 20-60 minutes.

15. The method of any of Aspects 1-14, wherein the drying is performed at 145° C. inlet and 65° C. outlet.

16. A specialty pea flour produced by the process of any of Aspects 1-15.

17. A specialty pea flour comprising, on a dry basis:
a. 60-85% starch,
b. 5-20% fiber, and
c. 0.5-3% protein,
Wherein said specialty pea flour is derived from peas.

18. The specialty pea flour of Aspect 17, comprising on a dry basis:
a. 70-78% starch,
b. 10-22% fiber, and
c. 1-2% protein.

19. The specialty pea flour of any of Aspects 17-18, wherein said starch comprises 30-35% amylose.

20. The specialty pea flour of any of Aspects 17-19, further comprising:
a. 0.3-0.5% oil,
b. 0.1-0.7% ash,
c. ≤2% sugar, and
d. 2-3% resistant starch.

21. A specialty pea flour of any of Aspects 16-20 having a mean particle size ≥50 μm.

22 A specialty pea flour of any of Aspects 16-21 having a mean particle size of 75-80 μm.

23. A method of making a specialty pea flour composition comprising:
combining the specialty pea flour of any of Aspects 16-22 and water to form a slurry.

24. The method of Aspect 23, wherein the concentration of said specialty pea flour is 1-15% solids (w/v).

25. The method of Any of Aspects 23-24, wherein the concentration of said specialty pea flour is 2-10% solids (w/v).

26. The method of any of Aspects 23-25, further comprising heating said slurry.

27 The method of Aspect 26 wherein said heating is to 90-100 for 10-20 minutes.

28. The method of any of Aspects 23-27, wherein said composition is brought to a viscosity of 500-2000 cP at 60° C.

29. The method of any of Aspects 23-28, wherein said composition is brought to a viscosity of 1800-1900 cP at 60° C.

30. A specialty pea flour composition produced by the method of any of Aspects 23-29.

31. A composition comprising the specialty pea flour of any of Aspects 16-22 and water.

32. The composition of any of Aspects 30-31, wherein said specialty pea flour is at a concentration of 2-10% solids.

33. The composition of any of Aspects 30-32, wherein the concentration of said specialty pea flour is 7% solids in said water.

34. The composition of any of Aspects 30-33, wherein said composition is at a viscosity of about 500-2000 cP at 60° C.

35. The composition of any of Aspects 30-34, wherein the composition is at a viscosity of about 1800-1900 cP at 60° C.

36. A paper composition comprising the specialty pea flour of any of Aspects 16-22 and/or the composition of any of Aspects 28-33.

37. A method of increasing the strength of a paper product comprising applying to said paper product the composition of any of Aspects 30-35.

38. The method of Aspect 37, wherein the strength is measured by measuring stiffness using Technical Association of the Pulp and Paper Industry (TAPPI) T 566 standard test.

39. The method of Aspect 37, wherein the strength is measures by measuring short span compression.

40. The method of Aspect 39, wherein short span compression is tested according to TAPPI T826.

41. A method of adhering and/or laminating 2 or more paper products to each other comprising applying to one or more of said paper products the composition of any of Aspects 30-35 and bringing said paper products in contact with each other where said composition has been applied.

42. The method of Aspect 41, wherein at least one of said paper products is corrugated.

43. A method of increasing water resistance of a paper product comprising applying to said paper product the composition of any of Aspects 30-35.

44. A method of producing a drywall product comprising:
a. providing a panel of gypsum plaster and paper to cover said panel,
b. applying the composition of any of Aspects 30-35 to said panel and/or said paper, and
c. contacting said paper with said panel where said composition has been applied such that the paper covers said panel and is adhered to said panel by said composition.

45. A drywall product comprising:
a. a panel of gypsum plaster,
b. paper covering said panel, and
c. the specialty pea flour of any of Aspects 16-22.

46. A method of producing fiber board comprising:
a. mixing specialty pea flour of any of Aspects 16-22 and water to form a homogeneous adhesive,
b. optionally modifying said specialty pea flour,
c. combining a fibrous plant-based material and the specialty pea flour or modified specialty pea flour-containing adhesive and mixing to relative homogeneity, and
d. manufacturing a panel from the combined materials using standard molding and compressing techniques,

thereby producing a fiber board.

47. A fiber board produced by the method of Aspect 46.

48. A fiber board comprising the specialty pea flour of any of Aspects 16-22 and/or modified form thereof and a fibrous plant-based material.

49. Use of a specialty pea flour of any of Aspects 16-22 in the production of a charcoal briquette.

50. A charcoal briquette comprising the specialty pea flour of any of Aspects 16-22.

51. Use of a specialty pea flour of any of Aspects 16-22 as a tackifier in hydroseeding or hydromulching.

52. A hydroseeding or hydromulching composition comprising a specialty pea flour of any of Aspects 16-22.

53. Use of a specialty pea flour of any of Aspects 16-22 in the production of a fiberglass insulation product.

54. A fiberglass insulation product comprising a specialty pea flour of any of Aspects 16-22.

55. A method of producing plywood comprising:
a. mixing a specialty pea flour of any of Aspects 16-22 and water to form a homogeneous adhesive,
b. optionally modifying said specialty pea flour and/or adding an additional component to said homogeneous adhesive selected from the group consisting of isocyanate, polyvinyl alcohol, citric acid,
c. applying said adhesive to a first veneer and, optionally to a second veneer,
d. adhering at least one other veneer to said first veneer where said adhesive has been applied, and
e. optionally repeating steps a.-d. to add additional veneer(s),

Thereby producing plywood.

56. A plywood produced by the method of Aspect 55.

57. A plywood comprising a specialty pea flour of any of Aspects 16-22 as a component of the adhesive adhering the veneers of the plywood.

58. The method of Aspect 1 or 2, further comprising:
e. treating the specialty pea flour with an amylase to produce an amylase-treated specialty pea flour (ASPF).

59. An amylase-treated specialty pea flour (ASPF) produced by the method of Aspect 58.

60. A method of making an ASPF composition comprising:
a. combining the specialty pea flour of any of Aspects 16-22 and water to form a solution, and,
b. treating the specialty pea flour solution with amylase to form an ASPF composition.

61. The method of Aspect 60, wherein the treating step comprises:
i. combining an active amylase with the SPF solution,
ii. incubating the combined composition at a temperature in which the amylase is active, and
iii. deactivation the amylase to produce an amylase-treated specialty pea flour.

62. The method of Aspect 61, wherein combining comprises adding about amylase to the SPF solution at room temperature, adjusting pH and increasing the temperature to active range for the amylase.

63. The method of Aspect 62, wherein the pH is adjusted to about 6.0 and the temperature is adjusted to about 70° C.

64. The method of Aspect 62 or 63, wherein the temperature is increased to the preferred temperature within about 15 minutes and maintained at that temperature for 60-120 minutes.

65. The method of Aspect 61, wherein the deactivating temperature is about 95° C.

66. The method of Aspect 61 or 65, wherein the deactivating temperature is maintained for about 15 minutes.

67 An ASPF composition made by the method of any one of Aspects 61-66.

68. The SPF composition of Aspect 67 comprising 1-15% solids.

69 An ASPF composition comprising 10% solids having a viscosity of <20 cP at 60° C.

70. A paper composition comprising the ASPF Aspect 59 and/or the composition of any of Aspects 67-69.

71. A method of increasing the strength of a paper product comprising applying to said paper product the composition of any of Aspects 67-69.

### EXAMPLES

The following examples are put forth so as to provide those of ordinary skill in the art with a complete disclosure and description of how to make and use the present invention and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, temperature is in degrees Centigrade, and times are in minutes.

All publications and patent applications cited in this specification are herein incorporated by reference as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. All such modifications are intended to be included within the scope of the appended claims.

### Example 1: Specialty Pea Flour

Dried, hulled pea pulses were milled to a flour, mixed with water to form a slurry and hydrated at a concentration of 1:4 (w:w) flour to water at pH 9.5 and a temperature of 55° C. for 30 minutes. The slurry was then centrifuged for 10 minutes at 5000 g and the supernatant decanted off to leave a specialty pea flour. The SPF was washed at a concentration of 1:3 (w:w) flour to water at pH 9.5 and a temperature of 55° C. for 20 minutes. The SPF was then dried in a dryer unit at 140° C. inlet and 65° C. outlet to a moisture level of 8-10%.

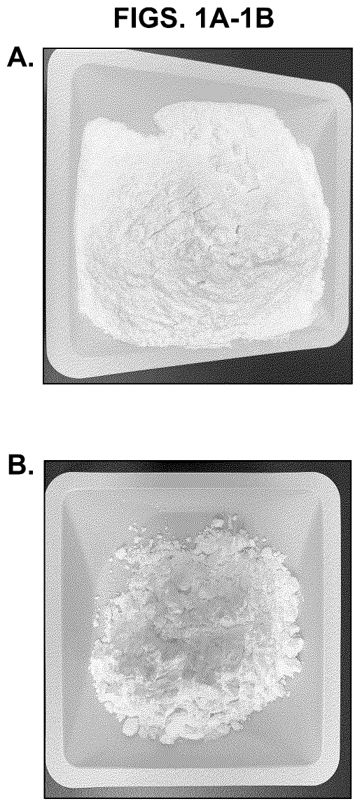

FIGS. 1A and 1B show examples of specialty pea flour and commercial corn starch (CS: modified—hydroxyethylated), respectively. Table 1 shows the composition of the SPF and commercial corn starch.

TABLE 1

| Components | SPF | CS |
|---|---|---|
| Protein (% DB) | ≤2% | 0.25 |
| Starch (% DB) | 70-84 | 91 |
| Moisture (%) | 7-10 | 12 |
| Oil (%) | 0.3-0.5 | — |
| Ash (%) | 0.1-0.7 | 0.1 |
| Fiber (%) | 5-20 | ≤1% |
| Sugar (%) | ≤2% | — |
| Resistant starch (%) | 2-3% | — |

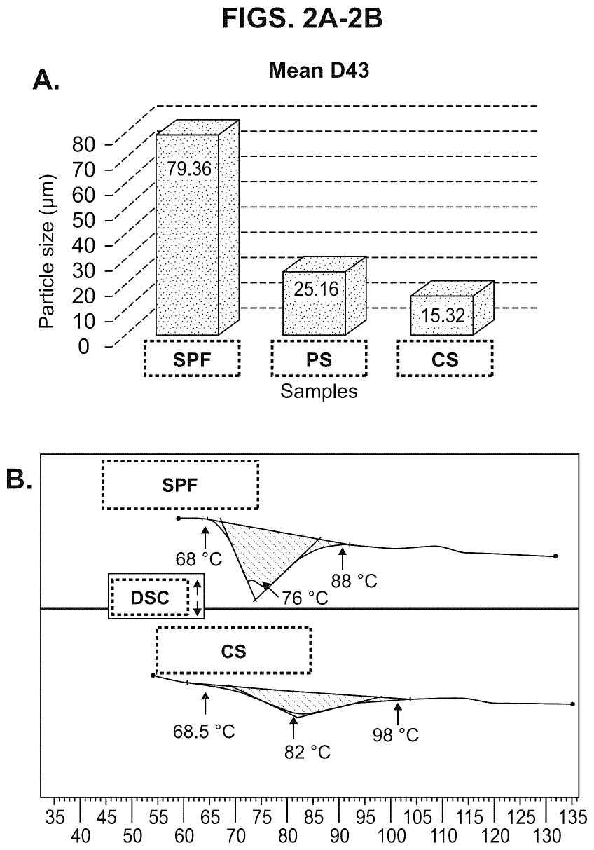

The SPF was analyzed for certain physical characteristics. FIG. 2A shows the relative size of the particles of SPF, commercial pea flour and commercial corn starch. Mean particle size is shown for D(4,3) analysis of the three powders using a laser diffraction apparatus. The SPF of the invention has a notably larger particle size as compared with either corn starch or commercial pea flower. FIG. 2B differential scanning colorimetry analysis of SPF and commercial corn starch. Both show exothermal events, the SPF at slightly lower temperatures.

### Example 2: Specialty Pea Flour Compositions and Coated Paper

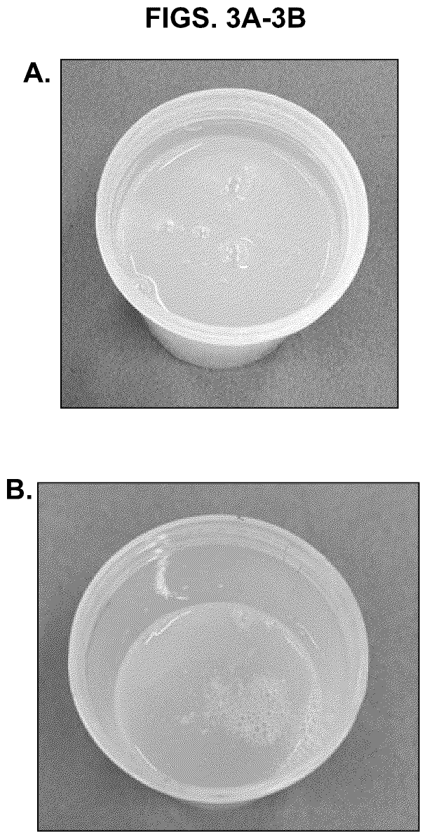

Slurrys of SPF were prepared at concentrations of 2-10% solids (w:w) in water. The slurries were heated to 90° C. for 20 minutes with agitation. Similar compositions of corn starch were also prepared for comparison purposes. The compositions were then cooled to 60° C. for application. Viscosity of the resulting compositions at 60° C. were determined using a Brookfield viscometer and are presented in centipoise (cP). FIGS. 3A and 3B show examples of SPF and modified CS, respectively prepared at about 7% solids in water. At 7.5% solids the SFP had a viscosity of about 1890 cP.

Base paper was coated with increasing amounts (coating weights) of SPF or corn starch composition using a Mayer rod drawdown coating technique, which provides for controlled coating thickness in the application of the compositions to the paper, so that coating is uniform and coat weight is readily determined by taring the pre-coated paper and weighing after coating to determine the coat weight. Various analyses were then performed on the coated paper and comparison between SPF and corn starch were made.

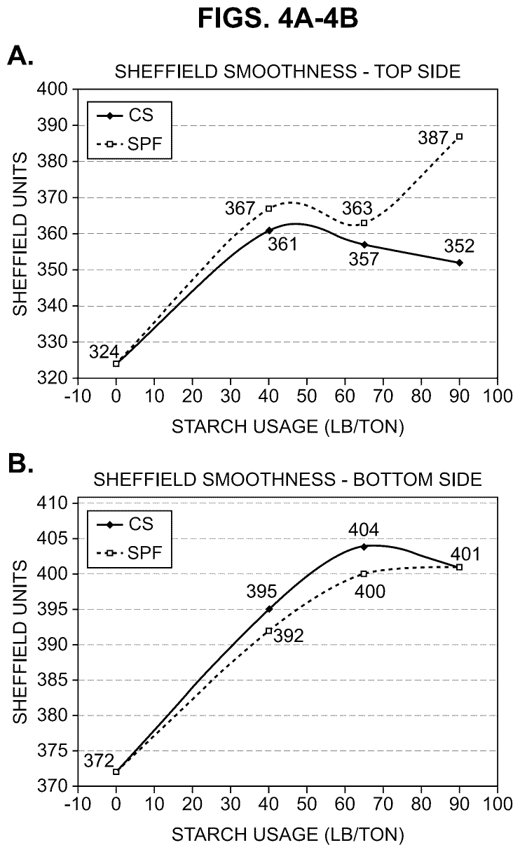

Base paper with increasing coating weights were measured for smoothness using a Sheffield smoothness tester. Analysis of the smoothness on the top side and bottom side of coated paper board is shown in FIGS. 4A and 4B, respectively, based on the Sheffield scale (TAPPI T 538). While both SPF and modified CS decreased the smoothness (increased the roughness) of the coated paper, the two compositions were comparable and fell within, for example, the smoothness specifications for archive boxes for the U.S. National Archives.

Water resistance of coated base paper was determined using the Cobb 2 minute test (TAPPI T 441) using a Cobb tester, which measures the amount of water absorbed by a paper sample over a specified period of time. FIGS. 5A and 5B show the Cobb test results for the top and bottom sides, respectively of base paper coated with an SPF composition or a corn starch composition. Both corn starch and SPF coatings improved water resistance of the base paper, but the SPF coating displayed slightly higher barrier properties.

Stiffness (bending resistance, a measure of strength) was determined for base paper coated on both sides with SPF and corn starch compositions using a Taber tester. The Taber Test (TAPPI T 469) measures the force needed to bend a specified dimension of paper 15 degrees. FIGS. 6A and 6B show the stiffness of base paper in the machine (longitudinal) and cross (transverse) directions, respectively, after coating with SPF and corn starch compositions. While both SPF and corn starch increased the stiffness of the paper, the SPF coating had a greater effect on increasing the strength of the paper.

### Example 3: Adhesive Strength of SPF and Corn Starch Compositions

The binding strength of SPF and modified corn starch compositions were used in a paper lamination test. During the lamination process, a steel roll was used to apply pressure on the laminated paper board sheets. The laminated paper was dried in a 105° C. oven for 10 minutes. Coat weight of the dried laminated sheets were quantified in grams/m².

A Scott Bond tester was used to test the lamination binding strength of the SPF and modified corn starch compositions using the Scott Bond test (TAPPI T 569). The test measures the force (in 0.001 ft pounds) necessary to separate the laminated paper board sheets. Table 2 shows an exemplary test comparison between SPF and corn starch compositions.

TABLE 2
Scott Bond test

| | | | Brook field | |
|---|---|---|---|---|
| | Scott bond | Coat weight | viscosity @ 60° C. | |
| Sample | (ft · lb/1000) | (g/m²) | (cP) | Solid % |
| SPF | 136 | 3.7 | 1890 | 7.8% |
| CS | 77 | 6.4 | 74 | 7.4% |

FIG. 7 plots the Scott Bond strength vs coat weight for commercial corn starch and two different batches of SPF composition. The SPF composition is consistent between batches and shows substantially higher binding strength than similar coat weights of corn starch.

In subsequent testing, 2%, 4% and 6% SPF displayed 2 to 3 times better binding strength (Scott Bond Test) compared to commercial corn starch.

### Example 4: Comparison of SPF and Commercial Corn Starch (CS)—Size Press

#33 paper coated with starch compositions comprising 6% solids and #77 paper coated with starch compositions comprising 4% solids were prepared using a commercial Size Press. Other than the starch source, all parameters were essentially the same for each paper type.

### 4A: Short Span Compression (STFI) Test

TABLE 3
STFI of paper treated as indicated with SPF.

| | | STFI (MD) | STFI (CD) |
|---|---|---|---|
| Base paper grade | Material | lb/in | lb/in |
| 33# | CS (unmodified) 6% | 33.5 | 18.4 |
| | CS (modified) 6% | 34.9 | 16.7 |
| | SPF 6% | 34.6 | 16.0 |
| 70# | CS (modified) 4% | 26.3 | 11.6 |
| | SPF 4% | 26.2 | 12.2 |

Short-span compression testing (STFI) is edge crush testing used to determine a liner board compressive strength. A sheet of the tested material is inserted into pneumatic clamps precisely aligned to produce a sample-free length of only 0.70 mm. The test is performed in the longitudinal direction of the liner board (machine direction; MD) and the cross direction (CD), according to TAPPI T 826. Paper of different weights were treated with SPF and commercial starches (CS), both unmodified cornstarch and modified (ethylated). Results, shown in Table 3, confirm that the SPF of the present invention provides comparable STFI strengthening to treated liner board.

### 4B: Tensile Index

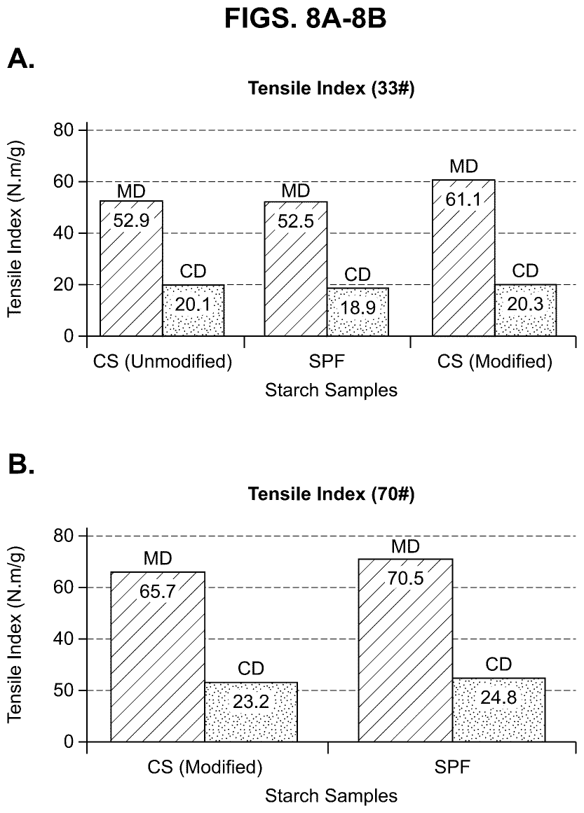

Tensile index was determined according to TAPPI T 494. Results for the different starches are shown in FIGS. 8A and 8B.

### 4C: Burst Index

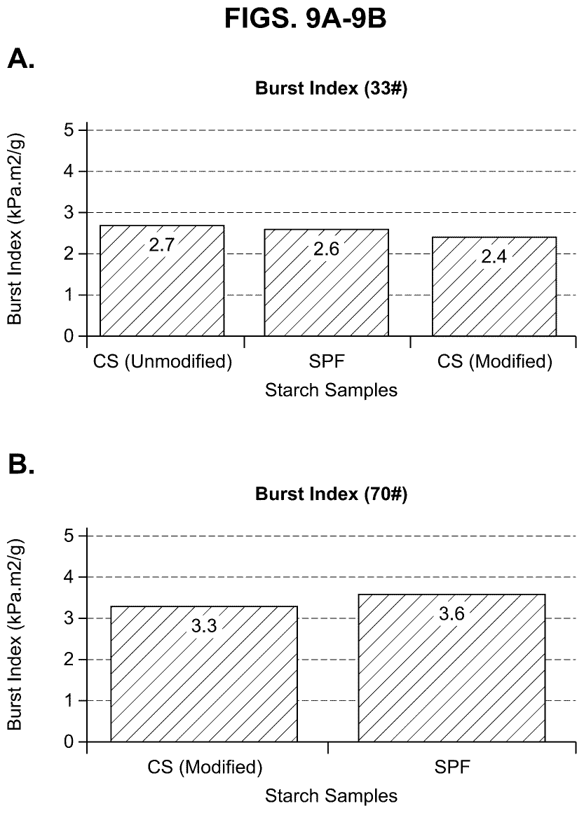

Burst index was determined according to TAPPI T 403. Results for the different starches are shown in FIGS. 9A and 9B.

### 4D: Tear Index

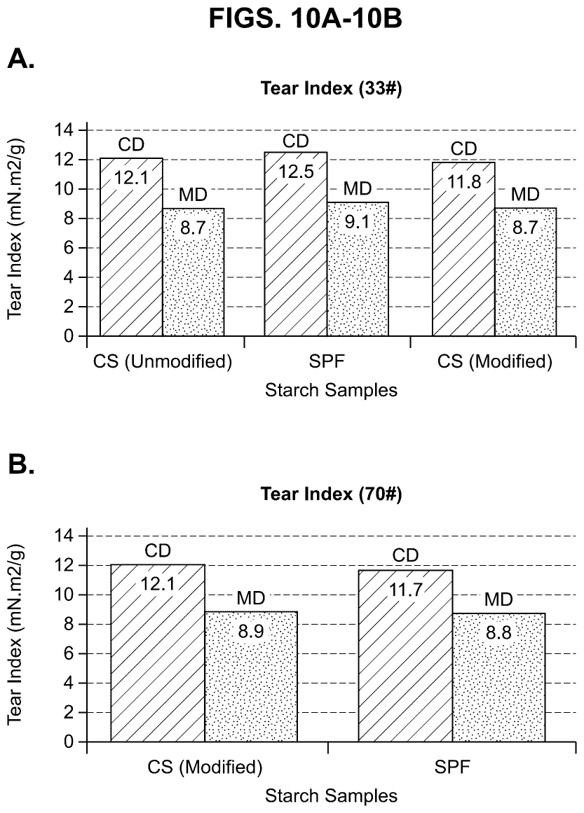

Tear index was determined according to TAPPI T 414. Results for the different starches are shown in FIGS. 10A and 10B.

### 4E: Stretch

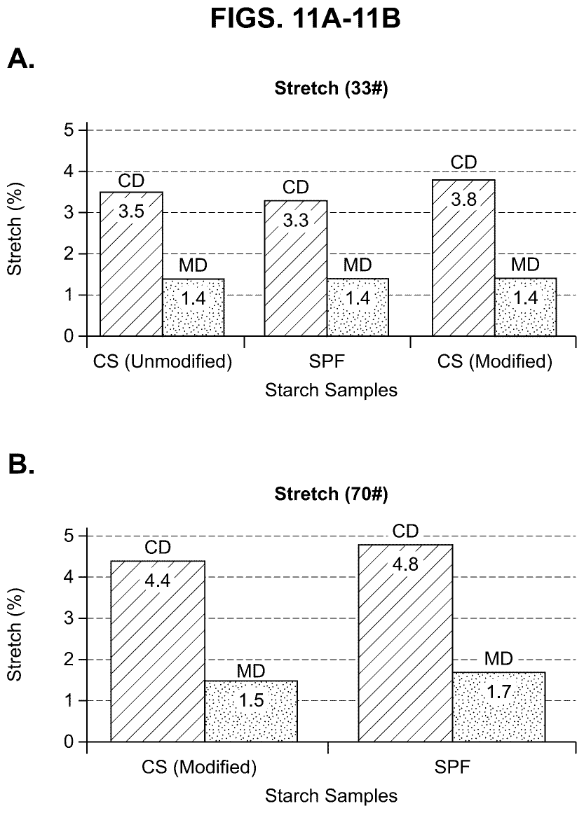

Stretch was determined after sizing of the paper as described above papers. Results for the different starches are shown in FIGS. 11A and 11B.

### 4F: Cobb Size

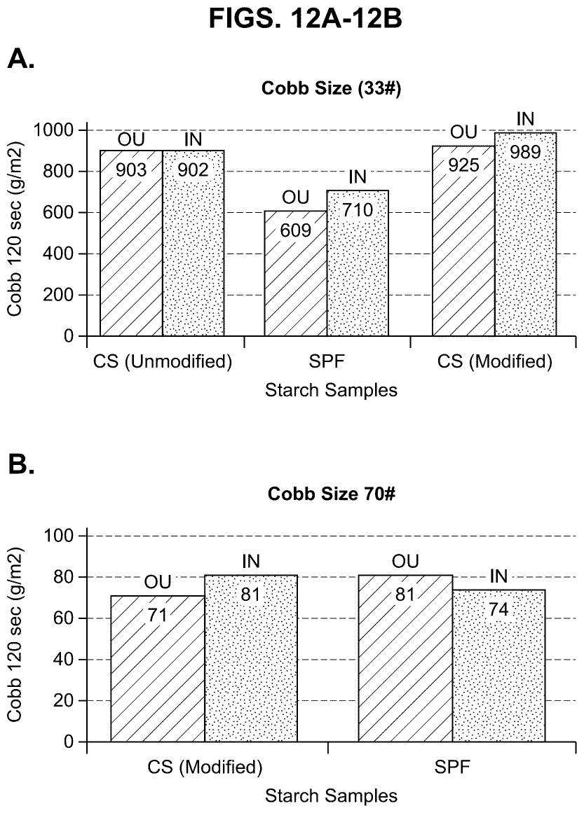

Cobb size was determined according to TAPPI T 441. Results for the different starches are shown in FIGS. 12A and 12B.

### 4G: Taber Stiffness

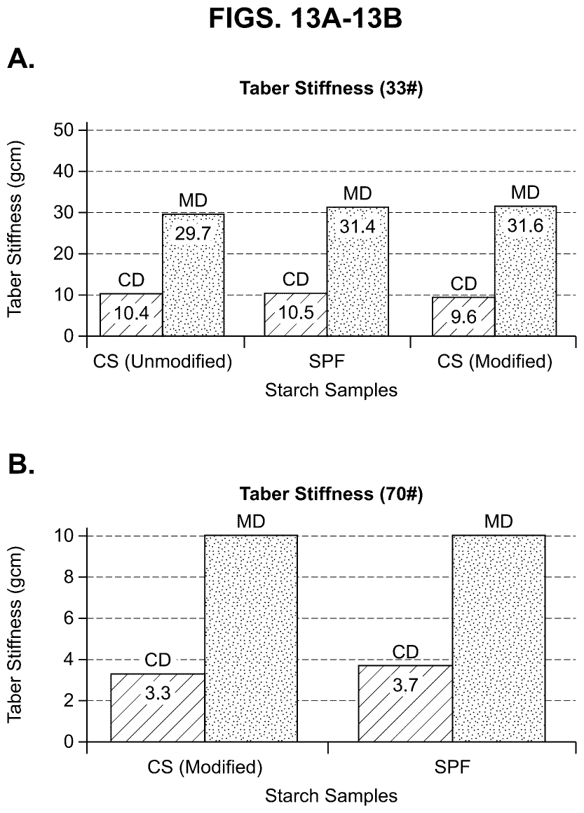

Taber Stiffness was determined according to TAPPI T 469. Results for the different starches are shown in FIGS. 13A and 13B.

In summary, SPF showed comparable tensile index, burst index, comparable or better STFI and stretch, and better tear index, Taber stiffness and barrier properties (Cobb Size) compared with commercial corn starch.

### Example 5: Amylase Treatment of SPF

SPF was treated with amylase (Novozyme BAN 480L). Enzyme treatment was performed following Novozyme's instructions, and the dosage was 1.0% dry to dry basis. Enzyme was added to starch solution at room temperature, while the pH of the starch solution was adjusted to 6.0 with diluted acetic acid. The starch solution was then heated up to 70° C. within 15 min and maintained at 70° C. for 90 min with constant agitation. At the end of treatment, the solution was heated to 95° C. for 15 min to deactivate the enzyme.

For reference, unmodified CS was treated using the same procedure. In addition modified CS was heated to 95° C. for 20 minutes without enzyme treatment.

Starch solution was cooled down to 60° C. before drawdown coating. The based sheet was coated with a rod on both sides.

Table 4 shows the relative viscosity of the amylase treated SPF (ASPF), amylase treated unmodified corn starch (ACS) and modified corn starch. Amylase treatment significantly reduced the viscosity of SPF.

TABLE 4

| 10% Starch Solution | Viscosity at 60° C. (cP) |
|---|---|
| Modified CS | 26.2 |
| ACS | 10.4 |
| ASPF | 14.9 |

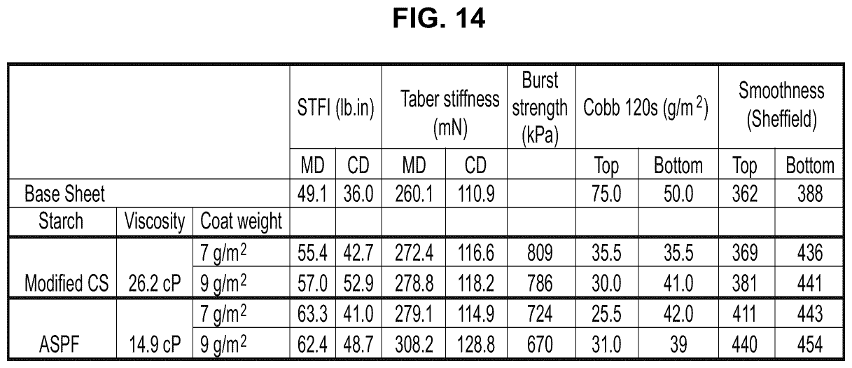

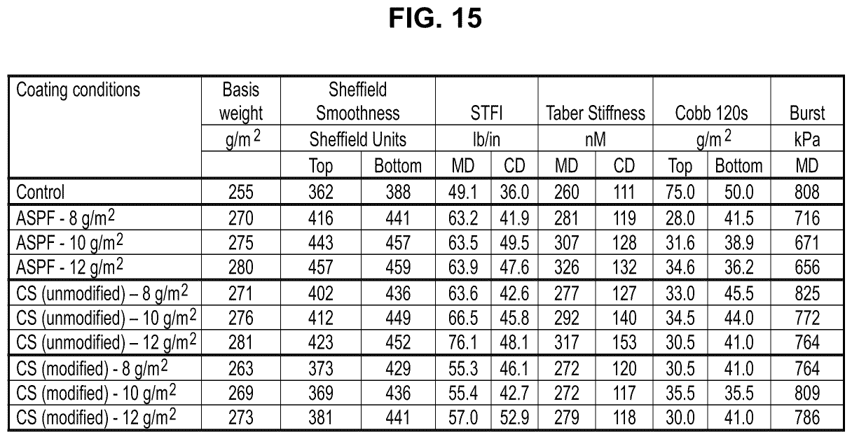

FIGS. 14 and 15 provide a comparison of various results for tests, as described above, performed independently with different coat weights of modified CS and ASPF.

1. A method of producing a Specialty pea flour (SPF) comprising:
a. Hydrating pea flour from ground (milled) pea pulses in a water slurry:
i) at a flour to water ratio of about 1:4 (w/v),
ii) at a pH of 7.5-10,
iii) at a temperature of 45-60° C.,
b. separating pea flour from protein-rich supernatant,
c. washing the separated pea flour, and
d. drying the separated pea flour,
thereby producing a specialty pea flour.

2. (canceled)

3. The method of claim 1, wherein the hydrating is performed at about pH 9.5.

4. The method of claim 1, wherein the hydrating is performed at about 55° C.

5. (canceled)

6. The method of claim 1, wherein the hydrating is performed for about 30 minutes.

7. (canceled)

8. The method of claim 1, wherein the separating involves centrifugation at about 5000 g for 10 minutes.

9. The method of claim 1, wherein the washing is with water.

10. The method of claim 1, wherein the washing is at a flour to water ratio of about 1:3 (w:w).

11. The method of claim 1, wherein the washing is performed at a pH of about 7.5-10.

12. (canceled)

13. The method of claim 1, wherein the washing is performed at a temperature of about 55° C.

14. The method of claim 1, wherein the washing is performed for about 20-60 minutes.

15. The method of claim 1, wherein the drying is to a moisture content of about 8-10%.

16. A specialty pea flour produced by the process of claim 1.

17. A specialty pea flour comprising, on a dry basis:
a. 60-85% starch,
b. 5-20% fiber, and
c. 0.5-3% protein,
Wherein said specialty pea flour is derived from peas.

18. The specialty pea flour of claim 17, comprising on a dry basis:
a. 70-84% starch,
b 18-22% fiber, and
c. 1-2% protein.

19. The specialty pea flour of any of claim 18, wherein said starch comprises 30-35% amylose.

20. The specialty pea flour of any of claim 18, further comprising:
a. 0.3-0.5% oil,
b. 0.1-0.7% ash,
c. ≤2% sugar, and
d. 2-3% resistant starch.

21. A specialty pea flour of claim 18 having a mean particle size ≥50 μm.

22. A specialty pea flour of claim 19 having a mean particle size of 75-80 μm.

23.-35. (canceled)

36. A paper composition comprising the specialty pea flour of claim 16 or 18.

37. A method of increasing the strength of a paper product comprising applying to said paper product a composition comprising the specialty pea flour of claim 16 or 18.

38.-40. (canceled)

41. A method of adhering and/or laminating two or more paper products to each other comprising applying to one or more of said paper products a composition comprising the specialty pea flour of claim 16 or 18 and bringing said paper products in contact with each other where said composition has been applied.

42. (canceled)

43. (canceled)

44. A method of producing a drywall product comprising:
a. providing a panel of gypsum plaster and paper to cover said panel,
b. applying a composition comprising the specialty pea flour of claim 16 or 18 to said panel and/or said paper, and
c. contacting said paper with said panel where said composition has been applied such that the paper covers said panel and is adhered to said panel by said composition.

45. A drywall product comprising:
a. a panel of gypsum plaster,
b. paper covering said panel, and
c. the specialty pea flour of any of claim 16 or 18.

46. A method of producing fiber board comprising:
a. mixing specialty pea flour of any of claim 16 or 18 and water to form a homogeneous adhesive,
b. optionally modifying said specialty pea flour,
c. combining a fibrous plant-based material and the specialty pea flour or modified specialty pea flour-containing adhesive and mixing to relative homogeneity,
d. manufacturing a panel from the combined materials using standard molding and compressing techniques,
thereby producing a fiber board.

47. A fiber board produced by the method of claim 46.

48.-52. (canceled)

53. Use of a specialty pea flour of any of claim 16 or 18 in the production of a fiberglass insulation product.

54. A fiberglass insulation product comprising a specialty pea flour of claim 16 or 18.

55. A method of producing plywood comprising:
a. mixing a specialty pea flour of claim 16 or 18 and water to form a homogeneous adhesive,
b. optionally modifying said specialty pea flour and/or adding an additional component to said homogeneous adhesive selected from the group consisting of isocyanate, polyvinyl alcohol, citric acid,
c. applying said adhesive to a first veneer and, optionally to a second veneer,
d. adhering at least one other veneer to said first veneer where said adhesive has been applied, and
e. optionally repeating steps a.-d. to add additional veneer(s),
Thereby producing plywood.

56. A plywood produced by the method of claim 55.

57. (canceled)

58. The method of claim 1, further comprising:
e. treating the specialty pea flour with an amylase to produce an amylase-treated specialty pea flour (ASPF).

59.-71. (canceled)
